(19) United States
(12) Patent Application Publication
(10) Pub. No.: US 2026/0282128 A1
(43) Pub. Date: Sep. 17, 2026

(54) Method of Session Management for Personal IOT Network in a 5G System

(71) Applicant: GOOGLE LLC, Mountain View, CA (US)

(72) Inventor: Ching-yu Liao, Mountain View, CA (US)

(21) Appl. No.: 19/473,455

(22) PCT Filed: Apr. 8, 2024
(86) PCT No.: PCT/US2024/023652

§ 371 Date: Oct. 7, 2025

Related U.S. Application Data
(60) Provisional application No. 63/495,069, filed on Apr. 7, 2023.

(51) Int. Cl. H04W 76/14; H04L 65/1066; H04W 40/02

(52) U.S. Cl. CPC H04W 76/14; H04L 65/1066; H04W 40/02

(57) ABSTRACT

A core network (CN) receives, from a user equipment (UE) operating as a personal internet-of-things (IoT) network (PIN) element (PINE) with gateway capability (PEGC) to provide a direct connection between the UE and at least one PINE in a PIN, a request to establish or modify a first packet data unit (PDU) session associated with the PIN; and uses an identifier in the request that differentiates the first PDU session from a second PDU session to differentiate between the first PDU session and the second PDU session that is associated with a same data network and a same network slice as the first PDU session.

### CROSS-REFERENCE TO RELATED APPLICATION

This application claims priority to and the benefit of the filing date of provisional U.S. Patent Application No. 63/495,069 entitled “METHOD OF SESSION MANAGEMENT FOR PERSONAL IOT NETWORKS IN A 5G SYSTEM,” filed on Apr. 7, 2023. The entire content of the provisional application is hereby expressly incorporated herein by reference.

### FIELD OF THE DISCLOSURE

This disclosure relates generally to methods, devices, and articles in wireless communication systems, such as 3GPP communication systems, and in particular to processing personal internet-of-things (IoT) network (PIN) traffic.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally, within a Personal IoT Network (PIN), a PIN Element with Gateway Capability (PEGC) is capable of providing 5G connectivity for PIN Elements (PINEs) connected to the PEGC (i.e., “behind the PEGC”). The PEGC allows PINEs within the same PIN to communicate with each other across different PEGCs with PEGC via a 5G Core Network (CN). A PIN Element with Management Capability (PEMC) is capable of managing a PIN.

A PIN may include at least one PEGC. A PEGC may support one or more PINs. A PEGC is a PIN member. A PINE may be a 3GPP user equipment (UE) (e.g., using sidelink communication over a PC5 interface) or a non-3GPP device (e.g., using Wi-Fi, Bluetooth) that is connected to a PEGC. A PIN can contain at least one UE with PEGC. A non-3GPP device may support IP-based connectivity (e.g., Wi-Fi, Bluetooth Low Energy) or non-IP-based connectivity (e.g., Bluetooth).

However, there is no clear mechanism for supporting PIN communication between a PINE and a data network (DN) via a PEGC and the 5G CN. Based on a network operator's policy, a UE with PEGC can use the UE route selection policy (URSP) rule provisioned by the 5G network to select and route specific PIN traffic indicated in a Traffic Descriptor (TD) to a specific packet data unit (PDU) session as indicated in a route selection descriptor (RSD) (e.g., in a data network name (DNN) or single network slice selection assistance information (S-NSSAI)). Currently, URSP handling for a PIN allows the UE with PEGC to decide whether to request a new PDU Session or use an existing PDU Session for PIN traffic associated with a PIN ID indicated in the TD. However, there is no mechanism to differentiate PDU sessions with the same DNN and S-NSSAI for enforcing the operator's policy for each PIN. Other PEMC and 5G CN issues remain open as well. For example, PIN deletion and deactivation procedures are not clear.

### SUMMARY

An example embodiment of the techniques of this disclosure is a method implemented in a core network (CN). The method includes receiving, from a user equipment (UE) operating as a personal internet-of-things (IoT) network (PIN) element (PINE) with gateway capability (PEGC) to provide a direct connection between the UE and at least one PINE in a PIN, a request to establish or modify a first packet data unit (PDU) session associated with the PIN; and using an identifier in the request that differentiates the first PDU session from a second PDU session to differentiate between the first PDU session and the second PDU session that is associated with a same data network and a same network slice as the first PDU session.

Another example embodiment of these techniques is a core network including one or more processors and configured to implement the method above.

### BRIEF DESCRIPTION OF THE DRAWINGS

FIG. 1 is a block diagram of an example wireless communication system that can implement one or more of the techniques of this disclosure for differentiating between PDU sessions in PINE communications.

FIG. 2 is a block diagram of an example protocol stack according to which the UE of FIG. 1 can communicate with the RAN of FIG. 1.

FIG. 3 is a service-based representation of the CN architecture, which the system of FIG. 1 can implement.

FIG. 4 is a reference-point based representation of the CN architecture, which the system of FIG. 1 can implement.

FIG. 5 is a flow diagram of an example method for identifying a destination PINE.

FIG. 6 is a block diagram of an example PDU session association for a PIN;

FIG. 7A is a flow diagram of an example method for indicating PIN ID to a core network, which can be implemented in a UE;

FIG. 7B is a flow diagram of another example method for indicating a PIN operation along with a PDU session ID to a core network, which can be implemented in a UE;

FIG. 8 is a flow diagram of an example method for configuring a PDU session in accordance with a message transmitted in accordance with the method of FIG. 7A or 7B, which can be implemented in an Access and Mobility Management Function (AMF);

FIG. 9 is a flow diagram of an example method for configuring a PDU session in accordance with a message transmitted in accordance with the method of FIG. 7A or 7B, which can be implemented in a Session Management Function (SMF);

FIG. 10 is a flow diagram of an example method for provisioning a UE operating as a PEGC with a URSP rule, which can be implemented in a Policy Control Function (PCF);

FIG. 11 illustrates an example scenario in which a core network provides a URSP rule for PIN and PIN group info provisioning, using a UE Configuration Update procedure for transparent UE Policy delivery; and

FIG. 12 illustrates an example scenario for a PDU session establishment request/modification procedure (with interaction among UDM/SMF/UPF/UE), using a UE-requested PDU Session Establishment for non-roaming and roaming with local breakout techniques.

### DETAILED DESCRIPTION OF THE DRAWINGS

One or more devices discussed below implement one or more of the following techniques. According to one approach, a UE indicates a PIN ID in a PDU Session establishment/modification request message for PIN service. According to another approach, a UE uses a combination of PDU Session ID and PIN service indication in a PDU Session establishment/modification request message for PIN service. One or more of network functions in the CN (e.g., an AMF, an SMF, and a PCF) support these requests from the UE. According to another approach, the PCF provisions URSP rules for different PINs based on operator policies. According to yet another approach, a route selection descriptor (RSD) component is added to support PDU Session ID or PIN ID selection. Further, the network functions can use a UE Configuration Update procedure to updating URSP rule for PIN services.

While this disclosure uses 5G networks as an example, one will appreciate that the principles of this disclosure generally apply to 3G networks, 4G networks, 6G networks, and future generations of networks.

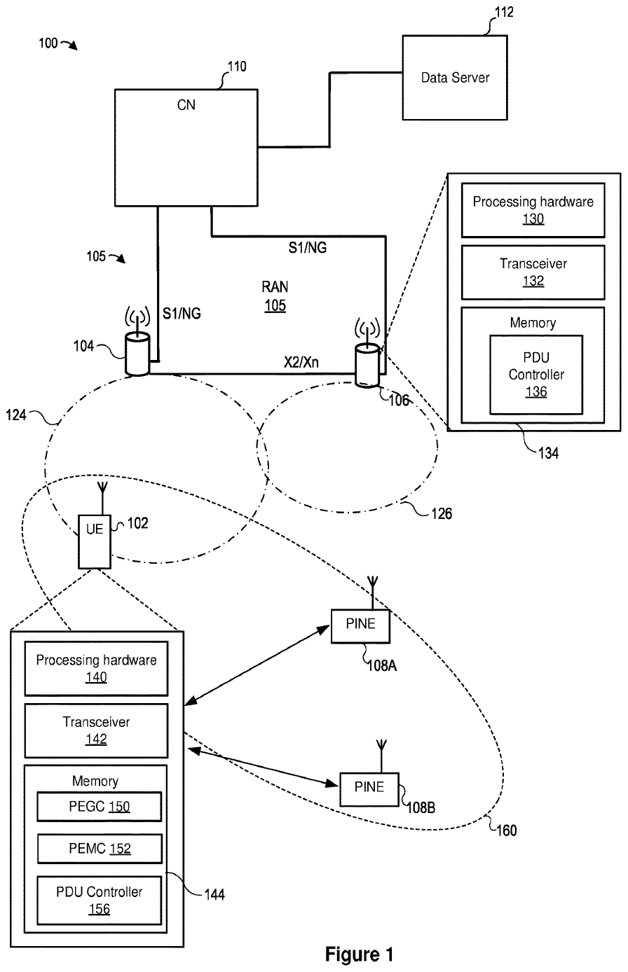

Referring first to FIG. 1, an example wireless communication system 100 can implement one or more of the techniques of this disclosure for handling PDU sessions. The example wireless communication system 100 includes a UE 102, PINEs 108A and 108B, a base station (BS) 104, a base station 106, and a core network (CN) 110, such as a fifth generation (5G) core (5GC). The base stations 104 and 106 can operate in a RAN 105 connected to the CN 110. The CN 110 can also be implemented as a sixth generation (6G) core or another suitable core network. The CN 110 connects to a data server 112, which can operate as an endpoint for one or more PDU sessions for which the UE 102 is the other endpoint.

The base station 104 covers a cell 124, and the base station 106 covers a cell 126. If the base station 104 is a gNB, the cell 124 is an NR cell. If the base station 124 is an ng-eNB, the cell 124 is an evolved universal terrestrial radio access (E-UTRA) cell. Similarly, if the base station 106 is a gNB, the cell 126 is an NR cell, and if the base station 126 is an ng-eNB, the cell 126 is an E-UTRA cell. The cells 124 and 126 can be in the same Radio Access Network Notification Areas (RNA) or different RNAs. The cells 124 and 126 can partially overlap, so that the UE 102 can select, reselect or hands over from one of the cells 124 and 126 to the other. In general, the RAN 105 can include any number of base stations, and each of the base stations can cover one, two, three, or any other suitable number of cells. The UE 102 can support at least a 5G NR (or simply, “NR”) air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

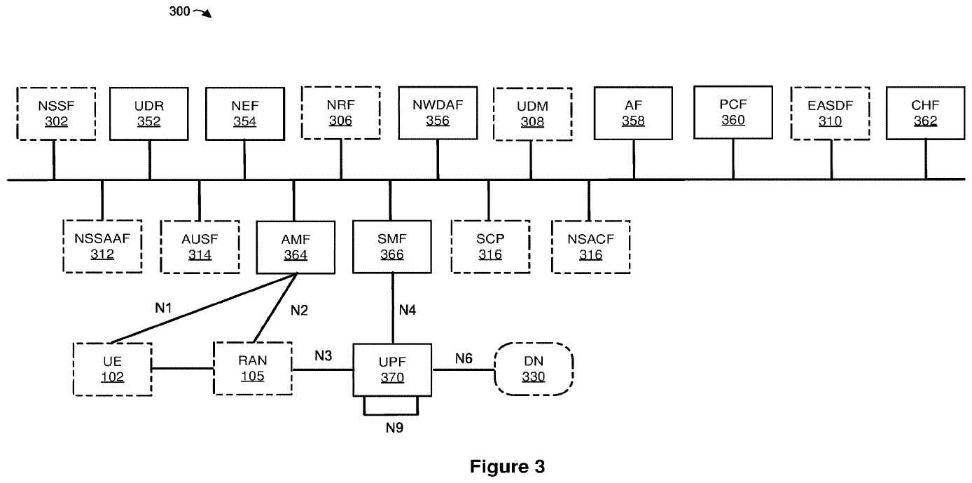

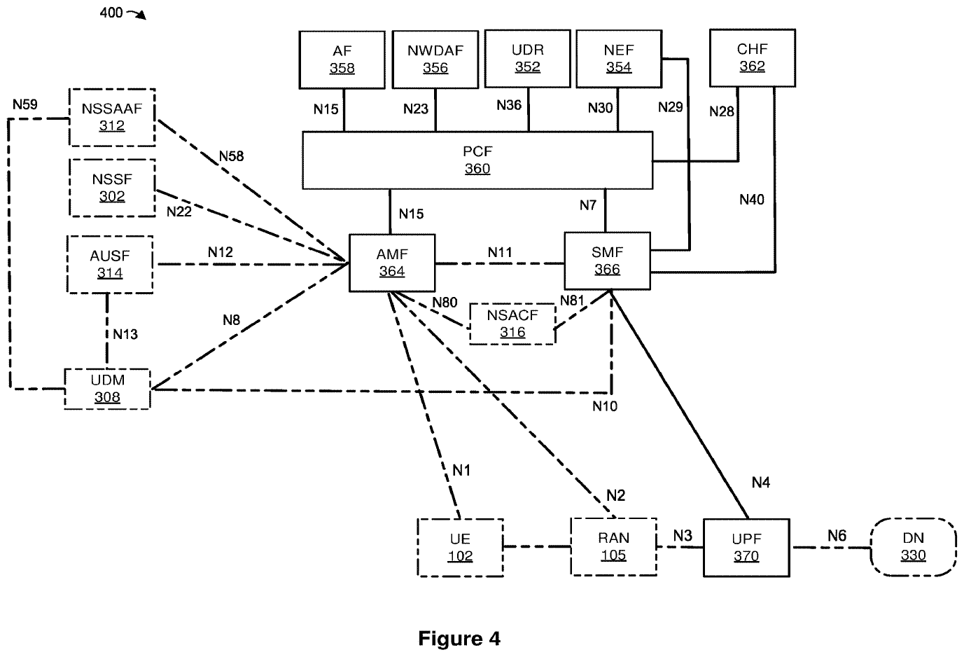

Several network functions (NFs) that make up the CN 110 are discussed below with reference to FIGS. 3 and 4. One or more of the NFs of the CN 110 coordinate PDU session differentiation as described below.

While not depicted in FIG. 1 to avoid clutter, the CN 110 may include processing hardware, which may include one or more general-purpose processors (e.g., CPUs) and a non-transitory computer-readable memory storing instructions that the one or more general-purpose processors execute. Additionally or alternatively, the processing hardware can include special-purpose processing units. The processing hardware may be configured to implement the techniques of this disclosure for handling PINE-to-PINE communications.

The base station 104 is equipped with processing hardware 130 that can include one or more general-purpose processors (e.g., CPUs) and a non-transitory computer-readable memory 134 storing instructions that the one or more general-purpose processors execute (not shown). Additionally or alternatively, the processing hardware can include special-purpose processing units. The base station 104 also includes a transceiver 132 to communicate with UEs such as the UE 102 over a radio interface. The base station 104 can implement, as a set of software instructions for example, a PDU controller 136 to support transfer of PDU packets and management of PDU sessions.

The UE 102 is equipped with processing hardware 140 that can include one or more general-purpose processors such as CPUs and non-transitory computer-readable memory storing machine-readable instructions executable on the one or more general-purpose processors, and/or special-purpose processing units. The UE 102 also includes a transceiver 142 to communicate with the RAN 105 over a radio interface.

Further, the UE 102 includes a memory 144 storing instructions that implement a PEGC module 150, a PEMC module 152, and PDU controller 156. With the PEGC module 150 and necessary hardware components (which may be included in or in addition to the processing hardware 130A and/or transceiver 132A), the UE 102A is a PEGC and capable to provide data network (DN) connectivity via a network (e.g., a 5G network) for PINEs (such as the PINE 108A) and/or provide relay functionality for communication between PINEs (such as between the PINEs 108A and 108B).

The UE 102A is configured to support a PIN 160 and operate as the PEGC 150 within the PIN 160. The PIN 160 is a configured and managed group of PINEs (including the PINE 108A) that are able to (1) communicate with each other directly or via PEGCs (including the UEs 108A and 108B), or (2) use a PEGC to communicate with devices or servers that are outside of the PIN via the 5G network. Generally speaking, a PIN includes at least one PEGC and is managed by PINEs with Management Capability (i.e., PEMC(s)). PIN management may be achieved with the support by an application function (AF) if an AF is deployed for PEMG. One will appreciate that the PIN 122A may include more than one PINEs, supported by more than one PEGCs and more than one PEMCs. One will also appreciate that more than PINEs may be connected to the UE 102.

The PINE 108A is a 3GPP UE or non-3GPP device that can communicate within the PIN 120 (via PINE-to-PINE direct or indirect connection) or outside the PIN 120 via a PEGC and a CN (such as the CN 110). In the depicted example, the PINE 108A is connected to the UE 102A. The PINE 108B may be configured in a similar way as PINE 108A. In the depicted example, the PINE 108B is connected to the UE 102B.

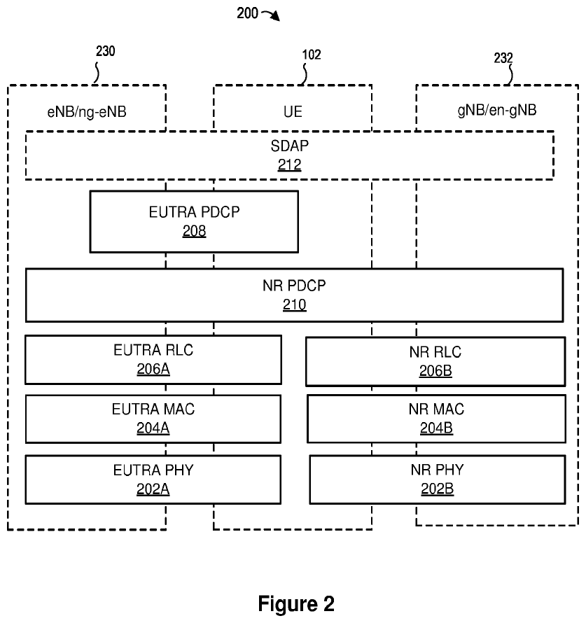

FIG. 2 illustrates, in a simplified manner, an example protocol stack 200 according to which the UE 102A, 102B, or 102C can communicate with an eNB/ng-eNB 230 or a gNB 232 (e.g., one or more of the base stations 104, 106). In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2). The UE 102A, 102B, or 102C, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102A or 102B can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2) to exchange RRC messages or non-access-stratum (NAS) messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, Internet Protocol (IP) packets, or Ethernet packets.

FIG. 3 is a service-based representation 300 of an example CN architecture, which the system of FIG. 1 can implement. In the representation 300, the overall non-roaming reference architecture of the policy and charging control (PCC) framework for the 5GS includes components illustrated using solid lines, and the other components are illustrated using dashed lines. According to this representation, network functions enable other authorized network functions to access their services. The components that are outside the PCC framework include a Network Slicing Selection Function (NSSF) 302, a Network Repository Function (NRF) 306, a Unified Data Management (UDM) 308, an Edge Application Server Discovery Function (EASDF) 310, a Network Slice Specific Authentication and Authorization Function (NSSAAF) 312, an Authentication Server Function (AUSF) 314, a Service Communication Proxy (SCP) 316, and a Network Slice Admission Control Function (NSACF) 318. The non-PCC architecture further includes the UEs 102A and 102B, the PINEs 108A and 108B, and the (R)AN 105.

The PCC framework in the architecture 300 includes a Unified Data Repository (UDR) 352, a Network Exposure Function (NEF) 354, a network data analytics function (NWDAF) 356, an Application Function (AF) 358, a Policy Control Function (PCF) 360, a Charging Function (CHF) 362, an Access & Mobility Management Function (AMF) 364, a Session Management Function (SMF) 366, and a User Plane Function (UPF) 370.

The AMF 364 is generally configured to manage registration, connection, and mobility of a UE (such as the UE 102A or 102B) and provide transport for session management (SM) messages between the UE 102A or 102B and the SMF 366. In some implementations, the AMF 364 is configured to generate logical interface IDs, as will be described below in detail.

The SMF 366 is generally configured to manage sessions, allocate IP addresses for UEs, and provides downlink (DL) notifications. In some implementations, the SMF 366 also includes following functionalities for PIN service: providing per-QoS flow non-3GPP QoS assistance information to the UE (e.g. PEGC), and supporting IP address allocation to UE and PDR configuration with packet filter set for PIN to UPF for framed routing based on PIN group information from the UDM 308.

The UDM 308 is generally configured to handle user identification, access authorization based on subscription data, and subscription management. In some implementations, the UDM 308 is configured to generate or change logical interface IDs, as will be described below in detail. In some implementations, the UDM 308 supports the functionality of PIN group management handling.

The UDR 352 is generally configured to store subscription-related information, such as subscription data, policy data, structured data for exposure, and application data. In some implementations, the UDR 352 is configured to store PIN communication configuration information, as will be described below in detail.

The UPF 370 is generally configured to handle packet routing and forwarding. In some implementations, the UPF 370 includes a functionality of supporting PDR configuration with a packet filter set for the PIN.

The NEF 354 is generally configured to expose a network's capabilities and services to authorized third-party applications.

The AF 358 in some deployment operates in a trusted domain 311 or outside the trusted domain 311, i.e., in a non-trusted domain. The trusted domain 311 is generally internal to the CN 110 and includes such components as the UDM 308, the UDR 352, the PCF 360, the AMF 364, the SMF 366, and the UPF 370. Generally speaking, an AF operating outside the trusted domain 311 (such as operated by an authorized third-party entity) can access the network functions of the CN 110 only via the NEF 354, whereas an AF operating within the trusted domain 311 can access at least some of the network functions of the CN 110 directly, or may access these functions via the NEF 354 in some deployments. In some deployments, the AF 358 is included in a PIN application server 390.

The UE 102A (PEGC) or the AF 358 may provide QoS flow parameters to the CN 110. The AF 358 that supports PIN service may also influence traffic routing for PDU sessions for PIN traffic. The PIN traffic can be categorized into following types: (1) between two PINES, which is via 5G core network when the two PINEs connect to different PEGCs; (2) between PINE and PEMC via a PEGC and 5G core network; (3) between PINE and DN via a PEGC and 5G core network; (4) Between PEGC and DN via 5G core network.

The UE 102A (PEGC) or the AF 358, if deployed for a PEMC, may manage a PIN and PINEs using user plane traffic, including PIN traffic or non-PIN traffic, which is “on top” (layered over) of available connection, such as (1) between two PINEs using direct or indirect PINE-to-PINE communication in case of PIN/PINEs managed by the PEMC at a PINE, or (2) between a PINE and a DN, where the AF 358 is located, via PEGC and 5G CN in case of PIN/PINEs managed by AF.

The UE 102A may support PDU session(s) associated with non-PIN service and PDU session(s) associated with PIN service. The UE 102A may include a PIN service indication in the PDU Session Establishment request message to trigger session management for PIN in 5G core network if the request is for PIN services. [Solution 1 fits into here]

One PEGC may serve more than one PINs. In such scenarios, the PEGC may have at least one PDU session for each PIN if the PIN traffic is via PEGC/5GC (5G Core Network). Based on an operator's policies and URSP rules, one PEGC serving more than one PINs may have one PDU session for each PIN or share one PDU session for PIN service. In the scenarios where multiple PDU sessions are with the same DNN and S-NSSAI for different PINs, a PEGC indicates a PIN ID as one of PDU session attributes in a PDU Session Establishment/Modification request.

One PIN may be served by more than one PDU sessions for the PEGC. Based on an operator's policies and URSP rules, one PEGC serving one PIN may use different PDU Sessions for different groups of PINEs. The techniques discussed below allow the UE and network functions to differentiate different PDU sessions with the same DNN and S-NSSAI.

If a PDU Session Establishment/Modification request is for a PIN service, the SMF may request PIN subscription of the PEGC from the UDM to (1) perform IP address allocation for a PIN or a group of PINEs of a PIN and (2) configure a UPF with PDR including a packet filter set that indicates a destination PIN, e.g., using an External Group Identifier or an IP address group, or a destination group of PINEs within the same PIN. For IP PDU Session Type, the Packet Filter Set may support Packet Filters based on any combination of: (1) a source/destination IP address or IPv6 prefix, (2) a source/destination port number, (3) a protocol ID of the protocol above IP/Next header type, (3) a type of Service (TOS) (IPv4)/Traffic class (IPv6) and Mask, (4) a flow label (IPv6), (5) a security parameter index, (6) a packet filter direction, and/or (7) source/destination PIN IP address or IPv6 prefix.

For PINE-to-PINE indirect communications, the PEGC may base on IP header information to route PIN traffics to a destination PIN (in scenarios where multiple PINs share a PDU session) or a PIN subgroup (in scenarios where multiple PDU sessions support one PIN). Ultimately, the PEGC may forward PIN traffics to destination PINEs (including UEs or non-3GPP devices) based on the IP address information of a destination PINE, e.g., MAC address mapped from a virtual interface ID in an IPv6 header.

For PIN traffics, the PEGC indicates a PIN ID to differentiate PDU sessions with same DNN and S-NSSAI for different PINs.

FIG. 4 is a reference-point based representation 400 of an example 5GS architecture. In FIG. 4, the non-roaming reference architecture of the PCC framework for the 5GS is illustrated as blocks and connections with solid lines, and components and connections outside the PCC framework are illustrated using dashed lines.

The communication system shown FIGS. 1-4 in may include additional, fewer, and/or alternative devices or functionalities, and may be configured to perform additional, fewer, or alternate actions, including functionalities/actions described herein.

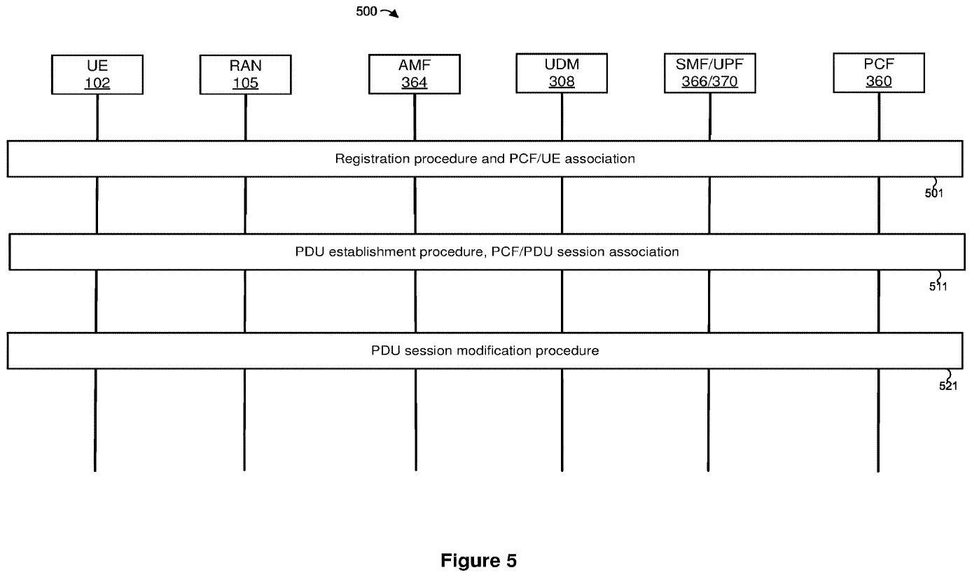

Referring to a scenario 500 of FIG. 5, during the registration procedure, the AMF determines 501 whether the UE 102 is authorized to use XRM services based on the XRM Service Capability of the UE and the XRM Service Authorization included in the subscription data received from UDM as specified in TS 23.501 clause 5.7.

After successful registration, the UE requests 511 for PDU Session Establishment procedure and the NG-RAN capable of XRM services can perform PDU Set handling for the QoS flows in a PDU Session based on the XRM service authorization and information received from the SMF via N2 message and GTP-U header via N3 interface from the UPF. The PDU Session Establishment Procedure can be implemented as described in TS23.502 clause 4.3.2.2.

The UE or network initiate 521 PDU Session Modification Procedure for the existing PDU Session. The PDU Session Modification Procedure can be implemented as described in TS23.502 clause 4.3.3.2 and 4.3.3.3.

The UE may repeat procedure 511 for multiple PDU Sessions which are associated to the same or different DNN and S-NSSAI.

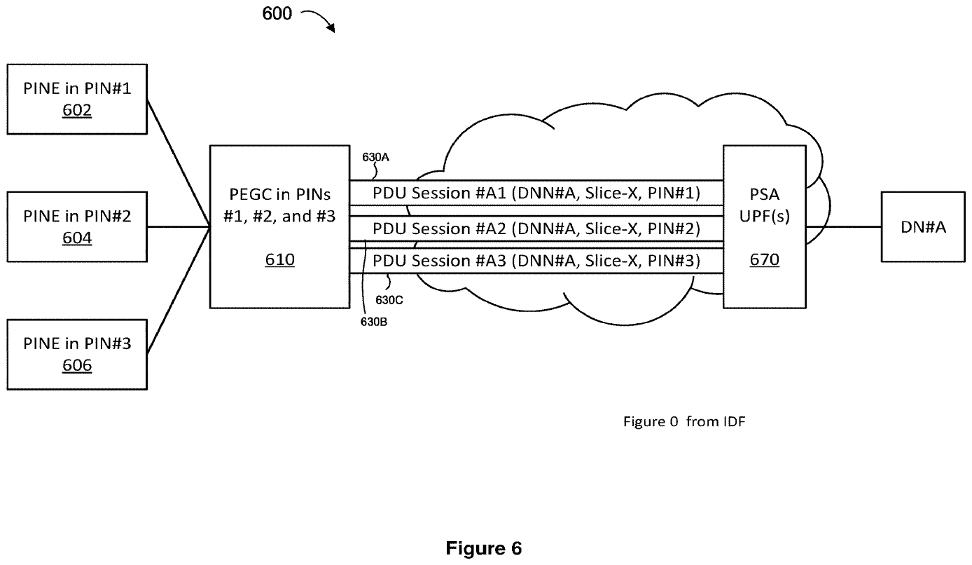

Next, FIG. 6 illustrates an example association 600 between PDU sessions 630A-C, a PEGC 610 operates in multiple PINs ##1-3, and PINEs 602, 604, and 606 operating in the PINs #1, #2, and #2, respectively. The PEGC 610 exchanges PDUs in PDU sessions 630A-C with a PSA-UPF 670. The PDU Session Attributes, the Data Network (DN) and the network slice, are the same for the PDU sessions 630A-C.

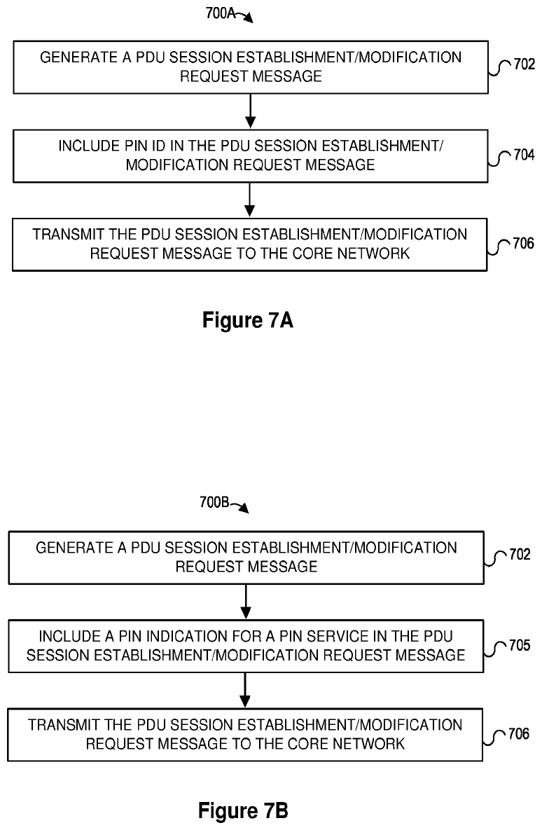

Next, example techniques for differentiating between PDU sessions are discussed with reference to FIGS. 7A-12.

FIG. 7A illustrates an example method 700A which can be implemented in a UE equipped with a PEGC, such as the UE 102. At block 702, the UE with PEGC generates a PDU session Establishment message or a PDU session Modification message. At block 704, the UE includes a PIN ID in the PDU session Establishment/Modification message generated at block 702. At block 706, the UE transmits the PDU session Establishment/Modification message to the core network (e.g., the CN 110 of FIG. 1).

Table 1 lists attributes of a PDU session similar to those listed in TS 23.501, clause 5.6.1, expect that that the this set of PDU session attributes includes a PIN ID. In this example, the PIN ID is a new PDU Session attribute.

TABLE 1

| | May be modified later during | |
|---|---|---|
| PDU Session attribute | the lifetime of the PDU Session | Notes |
| S-NSSAI of the HPLMN | No | (Note 1) (Note 2) |
| S-NSSAI of the Serving | Yes | (Note 1) (Note 2) (Note 4) |
| PLMN | | |
| DNN (Data Network Name) | No | (Note 1) (Note 2) |
| PDU Session Type | No | (Note 1) |
| SSC mode | No | (Note 2) |
| | | The semantics of Service and |
| | | Session Continuity mode is |
| | | defined in clause 5.6.9.2 |
| PDU Session Id | No | |
| PIN Id (NOTE X) | No | |
| User Plane Security | No | (Note 3) |
| Enforcement information | | |
| Multi-access PDU | No | Indicates if the PDU Session |
| Connectivity Service | | provides multi-access PDU |
| | | Connectivity Service or not. |

NOTE 1:
If it is not provided by the UE, the network determines the parameter based on default information received in user subscription. Subscription to different DNN(s) and S-NSSAI(s) may correspond to different default SSC modes and different default PDU Session Types
NOTE 2:
S-NSSAI(s) and DNN are used by AMF to select the SMF(s) to handle a new session. Refer to clause 6.3.2.
NOTE 3:
User Plane Security Enforcement information is defined in clause 5.10.3.
NOTE 4:
The S-NSSAI value of the Serving PLMN associated to a PDU Session can change whenever the UE moves to a different PLMN, while keeping that PDU Session.
NOTE X:
The PIN Id may be used for PIN service. Refer to clause 5.44.3.1.

FIG. 7B illustrates an example method 700B similar to the method 700A, except that the UE includes a PIN indication for a PIN service in a PDU session Establishment message or a PDU session Modification message.

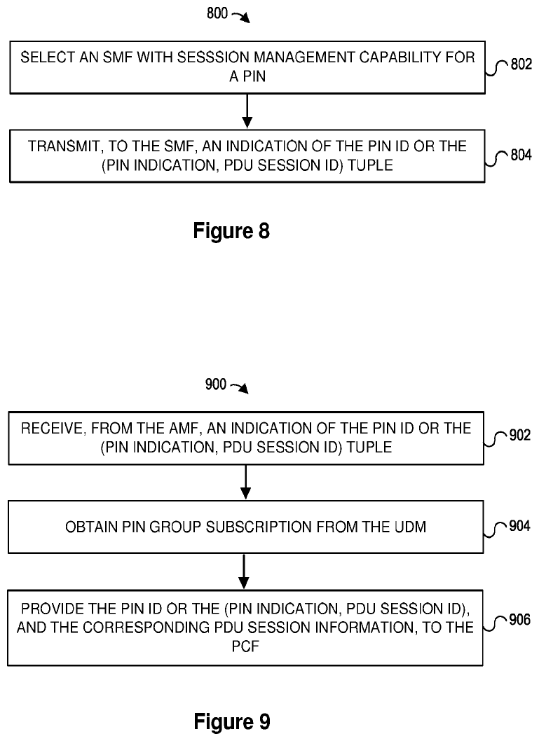

Referring to FIG. 8, an AMF (e.g., the AMF 364) receives a message from the UE transmitted in accordance with the method 700A or 700B and, at block 802, selects an SMF capable of session management for a PIN, e.g., the SMF 366. At block 804, the AMF transmits an indication of the PIN ID (per the method 700A) or the combination of PIN indication and PDU Session ID (per the method 700B) to the SMF.

Now referring to a method 900 of FIG. 9, the SMF can differentiate PDU sessions with same DNN and S-NSSAI for different PINs. In particular, the SMF at block 902 can receive the an indication of the PIN ID (per the method 700A) or the combination of PIN indication and PDU Session ID (per the method 700B) from the AMF. At block 904, the SMF can request PIN group subscription information from a UDM (e.g., the UDM 308). At block 906, the SMF can the provides PIN ID (per the method 700A) or the combination of PIN indication and PDU Session ID (per the method 700B) and the associated PDU Session information to a PCF (e.g., the PCF 360).

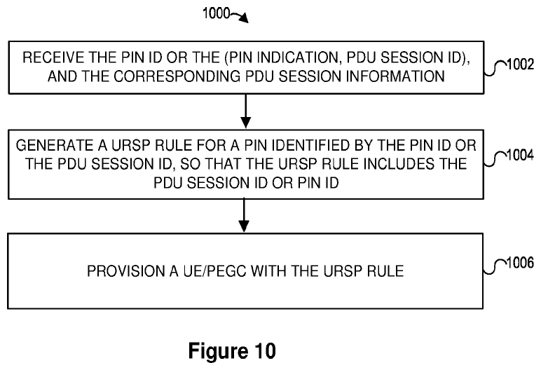

Next, FIG. 10 illustrates an example method 1000 for providing a URSP rule to a UE operating as a PEGC, e.g., the UE 102. The PCF can provision the rule based on the PIN ID (per the method 700A) or the combination of PIN indication and PDU Session ID (per the method 700B). The PCF can enforce the operator policy using a UE Configuration Update procedure to provision URSP rules to the UE with PEGC for the specific PIN identified by the PIN ID (per the method 700A) or PDU Session ID (per the method 700B).

In particular, at block 1002, the PCF receives the PIND or a combination of PIN indication and PDU Session ID, along with the corresponding PDU session information. At block 1004, the PCF generates the URSP rule for the PIN identified at block 1002, so that the URSP rule includes the PDU session ID or PIN ID. At block 1006, the PCF provisions the rule to the UE.

Table 2 illustrates an example modification of a known URSP rule for a PIN, when the PDU session is associated to one PIN. In particular, Table 2 illustrates an enhancement of the RSD with a PDU Session ID or PIN ID selection as an additional component, relative to TS23.503, Table 6.6.2.1-3 (Route Selection Descriptor):

TABLE 2

| Information | | | PCF permitted to | |
|---|---|---|---|---|
| name | Description | Category | modify in URSP | Scope |
| Route Selection | Determines the order in which | Mandatory | Yes | UE context |
| Descriptor | the Route Selection Descriptors | (NOTE 1) | | |
| Precedence | are to be applied. | | | |
| Route | This part defines the route | Mandatory | | |
| selection | selection components | (NOTE 2) | | |
| components | | | | |
| SSC Mode | One single value of SSC mode. | Optional | Yes | UE context |
| Selection | (NOTE 5) | | | |
| Network Slice | Either a single value or a list of | Optional | Yes | UE context |
| Selection | values of S-NSSAI(s). | (NOTE 3) | | |
| DNN Selection | Either a single value or a list of | Optional | Yes | UE context |
| | values of DNN(s). | | | |
| PDU Session | One single value of PDU | Conditional | Yes | UE context |
| Type Selection | Session Type | (NOTE 8) | | |
| PDU Session | One single value of PDU | Conditional | Yes | UE context |
| Type Selection | Session Type | (NOTE 8) | | |
| PDU Sessin ID | An indication to associate PDU | Conditional | Yes | UE context |
| or PIN ID | Session for a PIN as described | (NOTE 10) | | |
| Selection | in clause 5.44 of TS 23.501 [2]. | | | |
| Non-Seamless | Indicates if the traffic of the | Optional | Yes | UE context |
| Offload | matching application is to be | (NOTE 4) | | |
| indication | offloaded to non-3GPP access | | | |
| | outside of a PDU Session. | | | |
| ProSe Layer-3 | Indicates if the traffic of the | Optional | Yes | UE context |
| UE-to-Network | matching application is to be | (NOTE 4) | | |
| Relay Offload | sent via a ProSe Layer-3 UE-to- | | | |
| indication | Network Relay outside of a | | | |
| | PDU session. | | | |
| ProSe Multi- | Indicates if the traffic of the | Optional | Yes | UE context |
| path Preference | matching application is | (NOTE 9) | | |
| | preferred to be sent via a PDU | | | |
| | Session over the Uu reference | | | |
| | point and a ProSe Layer-3 UE- | | | |
| | to-Network Relay outside of a | | | |
| | PDU session. | | | |
| Access Type | Indicates the preferred Access | Optional | Yes | UE context |
| preference | Type (3GPP or non-3GPP or | | | |
| | Multi-Access) when the UE | | | |
| | establishes a PDU Session for | | | |
| | the matching application. | | | |
| PDU Session | An indication shared by | Optional | Yes | UE context |
| Pair ID | redundant PDU Sessions as | | | |
| | described in clause 5.33.2.1 of | | | |
| | TS 23.501 [2]. | | | |
| RSN | The RSN as described in | Optional | Yes | UE context |
| | clause 5.33.2.1 of | | | |
| | TS 23.501 [2]. | | | |
| Route Selection | This part defines the Route | Optional | | |
| Validation | Validation Criteria components | | | |
| Criteria | | | | |
| (NOTE 6) | | | | |
| Time Window | The time window when the | Optional | Yes | UE context |
| | matching traffic is allowed. The | | | |
| | RSD is not considered to be | | | |
| | valid if the current time is not in | | | |
| | the time window. | | | |
| Location | The UE location where the | Optional | Yes | UE context |
| Criteria | matching traffic is allowed. The | | | |
| | RSD rule is not considered to | | | |
| | be valid if the UE location does | | | |
| | not match the location criteria. | | | |

NOTE 1:
Every Route Selection Descriptor in the list shall have a different precedence value.
NOTE 2:
At least one of the route selection components shall be present.
NOTE 3:
When the Subscription Information contains only one S-NSSAI in UDR, the PCF needs not provision the UE with S-NSSAI in the Network Slice Selection information. The “match all” URSP rule has one S-NSSAI at most.
NOTE 4:
If this indication is present in a Route Selection Descriptor, no other components shall be included in the Route Selection Descriptor.
NOTE 5:
The SSC Mode 3 shall only be used when the PDU Session Type is IP.
NOTE 6:
The Route Selection Descriptor is not considered valid unless all the provided Validation Criteria are met.
NOTE 7:
In this Release of specification, inclusion of the Validation Criteria in Roaming scenarios is not considered.
NOTE 8:
This component shall be present when the Route Selection Component does neither include the “Non-Seamless Offload indication” nor “ProSe Layer-3 UE-to-Network Relay Offload indication”.
NOTE 9:
If this indication is present in a Route Selection Descriptor, ProSe Layer-3 UE-to-Network Relay Offload indication shall not be included in the Route Selection Descriptor.
NOTE 10:
Only applies to traffic to/from PINEs.

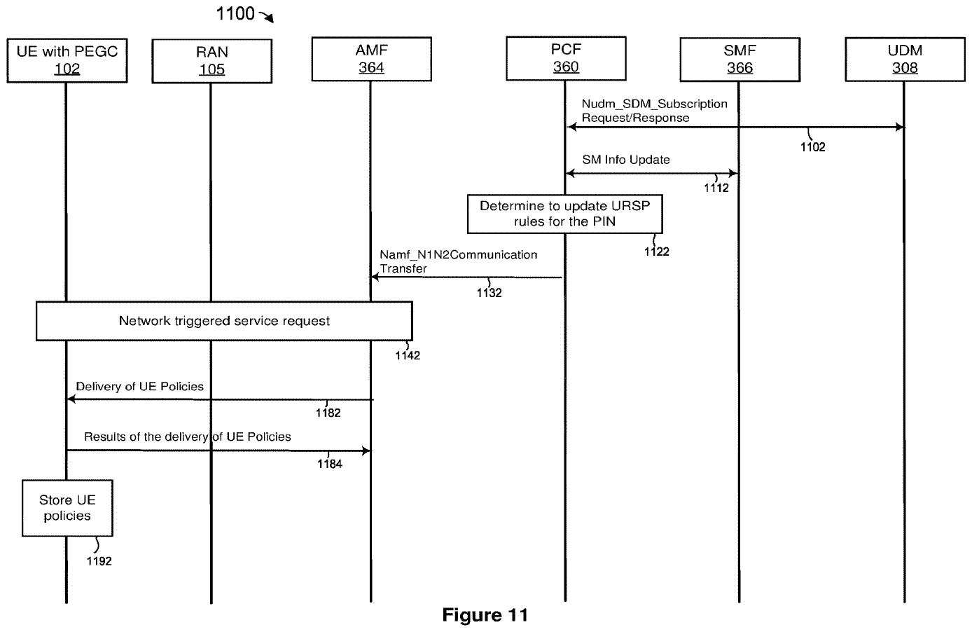

FIG. 11 illustrates an example scenario 1100 for a UE Configuration Update procedure, for updating a URSP rule for PIN services. The PCF 360 can implement the method of FIG. 10 discussed above. The CN 110 can provision the URSP rule for PIN services in accordance with TS23.502 clause 4.2.4.3 (“UE Configuration Update procedure for transparent UE Policy delivery”), for example. The PCF 260 can initiate this procedure is initiated in order to update UE policy information (i.e. UE policy) in the UE configuration, with the following modifications: (i) based on operator policy, the PCF 360 receiving the PIN ID and PDU Session ID for PIN services can determine to provision URSP rules to the UE 102 for the one more PINs the UE 102 supports; and (ii) the AMF 364 can deliver UE policies and PIN group information using a DL NAS Transport message.

In particular, referring to FIG. 11, the PCF 360, the UDM 308, and the PCF 360 operate 1102, 1112 to support a subscription: based on the operator policy or the subscription of the PCF 360 to the event notification for the change of PIN group data, the UDM 308 indicates to the PCF 360 when there is a change of PIN group data or PIN service subscriptions stored at the UDM 308 for the UEs with PEGC.

The PCF 360 determines 1122 to trigger UE configuration update procedure for updating URSP rule based on PDU Session information for PIN from SMF. The PCF 360 includes 1132 URSP rules for PIN with RSD enhancement for a target UE in a Namf_Communication_N1N2Message Transfer message to the AMF 364.

The AMF 364 initiates 1142 a network-triggered service request procedure (if the UE 102 is in the IDLE state). The AMF 364 delivers 1182, to the UE 102, UE policies using a DL NAS Transport message including the URSP rules. The UE 102 replies 1184 with the result of the delivery of UE policies. Then, the UE 102 stores 1192 the URSP rules.

Further, a UE with PEGC (e.g., the UE 102) can initiate a PDU Session Establishment/Modification request procedure for the PIN communication of its serving PINs. The 5G core network and the UE with PEGC in the PIN can support PIN communication in the PDU Session Establishment/Modification request procedure with the following addition for PIN service: (I) With PID ID or combination of PIN indication and PDU Session ID, the SMF performs the following: (1) asks the UDM for PIN group subscription of the UE with PEGC, (2) updates PIN ID or combination of PIN indication and PDU Session ID to the PCF and obtains PIN group policy from the PCF. (II) The SMF manages the PDU session information for PIN group as follows: (1) allocates an IPv6 prefix to PIN group which can be one or more PINs, PIN subgroups, one or more PINEs based on PIN group information from the UDM and group policies from the PCF, (2) binds a QoS flow per PIN group member with packet filter set including the associated IPv6 prefix for the PIN group; (3) configures the UPF via N4 session request message including (i) a packet detection rule (PDR) containing IPv6 prefixes associated to the target PIN group/subgroup using corresponding IPv6 prefixes information, and the target PINE using interface ID of the IPv6 address, and (ii) a Forwarding Action rule (FAR) for routing detected PIN traffic to the destined UE with PEGC that serves the PIN group/subgroup in the PIN. The N4 session request message includes routing information for the PIN groups/subgroup, (4) provides a QoS profile to the gNB over N3 for the QoS flow that shares the same QoS parameters, and (5) provides a QoS rule including QFI and packet filter set with source/destined PIN group information, using associated IPv6 prefix, to the UE with PEGC; (III) the UPF detects a particular packet based on PDR with packet filter set for PIN group, and route the detected PIN traffic to the source/destined UE with PEGC that serves the PIN group; and (IV) the UE with PEGC forwards the packets of the QoS flow toward the PINEs with the PIN group based on received packet filter set information of source/destined PIN group.

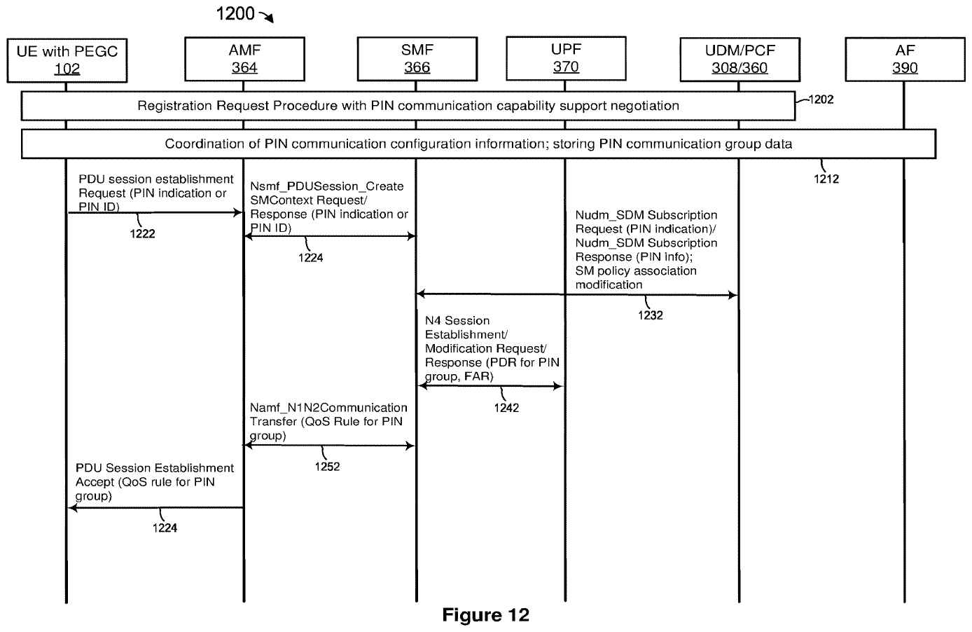

Referring to FIG. 12, a scenario 1200 can include the following events:
Event 1202: The UE performs Registration Request procedure, whereby the UE sends Registration Request message including PIN communication capability to the AMF. The AMF gets UE's subscription information related to PIN service and sends Registration Accept message including PIN indication, and PIN service information, e.g. Max. allowed number of PINEs, to the UE.
Event 1212: PIN communication configuration information coordination with UDM and the UDM stores PIN group data.
Event 1222: the UE sends PDU Session establishment request message including PDU Session ID and PIN ID or PDU Session ID and PIN indication for the PDU Session to the AMF.
Event 1224: the AMF sends Nsmf_PDUSession_CreateSMContext Request including PDU Session ID and PIN ID or PDU Session ID and PIN indication to the SMF and gets the Nsmf_PDUSession_CreateSMContext Response from the SMF.
Event 1232: the SMF sends Nudm_SM request message including UE ID, PIN indication or PIN ID, to get subscription data for the target UE identified by SUPI and target PIN identified by PIN ID, e.g. GPSI. In addition, the SMF provides SM Update message including PIN ID or PDU Session ID to the PCF and get PCC rules for the PIN group policy for the target UE and the target PIN.
Event 1242: the SMF can base on PIN group information from the UDM and PCC rules from the PCF to perform the following: QoS flow binding; configuring UPF via N4 interface, and sending an N4 Session Establishment/Modification Request to the UPF and the UPF acknowledges by sending an N4 Session Establishment/Modification Response. The N4 session Establishment/Modification request message includes the PDR with Packet Filter Set indicating source/destination PIN group and FAR with routing information towards one or more target UEs with PEGC which serve PINEs of the PIN group.
Events 1252, 1224: the SMF sends PDU Session Establishment/Modification Accept message including QoS rules with Packet Filter Set indicating source/destination PIN group, e.g using associated IPv6 prefix, to the UE with PEGC via AMF.

### Further Considerations

Further, the AF can play a role for a PEMC and/or application proxy. According to this approach, the AMF is deployed (or not deployed) depending to the PEMC context.

Regarding PIN deletion/deactivation/activation handling, because the PIN service is a subscription service, the subscriber can handle the PIN deletion/deactivation/activation using operator's account, which is out of scope of this specification.

Regarding the PEMC role in 5GC, for PEMC functionality of PIN management, the following definition and description in TS23.501 show that the PEMC is a logical entity which is de facto similar to a “PIN application” hosted by the UE with/without PEGC or a PINE behind a UE
Definition: PIN Element with Management Capability (PEMC): A PIN Element with capability to manage the PIN.
NOTE 3: A UE that is a PIN Element may both act as PEMC and PEGC.
Clause 5.44.1: A PIN includes at least one PEGC and at least one PEMC. The management of the PIN network and PIN Element (including the management role distribution between PEMC and AF) is out of the scope of this specification.
Clause 5.44.1: PIN and PIN elements are managed by specific PIN element with Management Capability (PEMC) and by an AF if AF deployed. A PIN includes at least one PEGC and at least one PEMC. The management of the PIN network and PIN Element (including the management role distribution between PEMC and AF) is out of the scope of this specification.
Annex P1: The PEMC and PEGC communicates with the PIN Application Server at the application layer over the user plane. The PEGC and PEMC can communicate with each other via direct communication using 3GPP access (e.g. PC5) or non-3GPP access (e.g. WiFi, BT) or via a PDU Session in the 5GS.

It is possible to resolve the open issues for PEMC role with the following features: PEMC functionality of PIN management depends on PIN application implementation. Clarify the AF for FEMC role to add “if AF deployed for PEMC”. PEMC or AF if deployed for PEMC manages PIN and PINEs using user plane traffic, including PIN traffic or non-PIN traffic, which is on top of available connections. For PIN traffic via PEGC/5GC with PDU session, the 5GC supports the policy control. The policy control is based on session management procedures.

A PEGC or an AF may provide QoS flow parameters to 5GC. An AF supports PIN service may also influence traffic routing for PDU sessions for PIN traffic. The PIN traffic can be categorized into following types:

Between two PINEs, which is via 5G core network when the two PINEs connect to different PEGCs.
Between PINE and DN via a PEGC and 5G core network.
Between PEGC and DN via 5G core network.

PEMC or AF if deployed for PEMC manages PIN and PINEs using user plane traffic, including PIN traffic or non-PIN traffic, which is on top of available connection, e.g. between two PINEs using direct or indirect PINE to PINE communication in case of PIN/PINEs managed by PEMC at a PINE or between PINE and DN, where AF is located, via PEGC and 5G CN in case of PIN/PINEs managed by AF.

### Additional Considerations

The following additional considerations apply to the foregoing discussion.

In some implementations, the paging message can be replaced by a paging record. In other implementations, the paging message can include one or more paging records, where each paging record pages a particular UE. For example, the paging message can include a paging record for the UE 102.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method implemented in a core network (CN), the method comprising:
receiving, from a user equipment (UE) operating as a personal internet-of-things (IoT) network (PIN) element (PINE) with gateway capability (PEGC) to provide a direct connection between the UE and at least one PINE in a PIN, a request to establish or modify a first packet data unit (PDU) session associated with the PIN; and
using an identifier in the request that differentiates the first PDU session from a second PDU session to differentiate between the first PDU session and the second PDU session that is associated with a same data network and a same network slice as the first PDU session.

2. The method of claim 1, wherein:
the identifier is a PIN identifier (ID) of the PIN.

3. The method of claim 1, wherein:
the identifier is a PDU ID of the first PDU session, the request further including a PIN indication.

4. The method of claim 1, wherein:
the receiving of the request and the using of the identifier are implemented in a Session Management Function (SMF).

5. The method of claim 4, further comprising:
providing, to a Policy Control Function (PCF), information for the first PDU session and the identifier.

6. The method of claim 1, further comprising:
generating, for the UE, a UE Route Selection Policy (URSP) rule with a route selection descriptor (RSD) including a PDU session ID of the first PDU session.

7. The method of claim 6, wherein:
the generating of the URSP rule includes applying operator policy.

8. The method of claim 6, further comprising:
providing the URSP rule to the UE using a UE configuration update procedure.

9. The method of claim 8, wherein:
the providing of the URSP rule to the UE includes transmitting, to an Access and Mobility Function (AMF), an Namf-N1N2CommunicationTransfer message including the URSP rule.

10. The method of claim 9, further comprising:
transmitting, from the AMF to the UE, a downlink (DL) non-access stratum (NAS) transport message including the URSP rule.

11. The method of claim 6, wherein:
the generating of the URSP rule is implemented in a PCF.

12. The method of claim 6, further comprising:
requesting PIN group subscription information from a unified data management function (UDM).

13. The method of claim 6, wherein:
the data network is identified by a data network name (DNN).

14. The method of claim 6, wherein:
the network slice is identified by a Single-Network Slice Selection Assistance Information (S-NSSAI).

15. A core network including one or more processors, the core network configured to:
receive, from a user equipment (UE) operating as a personal internet-of-things (IoT) network (PIN) element (PINE) with gateway capability (PEGC) to provide a direct connection between the UE and at least one PINE in a PIN, a request to establish or modify a first packet data unit (PDU) session associated with the PIN; and
using an identifier in the request that differentiates the first PDU session from a second PDU session to differentiate between the first PDU session and the second PDU session that is associated with a same data network and a same network slice as the first PDU session.

16. The core network of claim 15, wherein:
the identifier is a PIN identifier (ID) of the PIN.

17. The core network of claim 15, wherein:
the identifier is a PDU ID of the first PDU session, the request further including a PIN indication.

18. The core network of claim 15, wherein:
the receiving of the request and the using of the identifier are implemented in a Session Management Function (SMF).

19. The core network of claim 15, further configured to:
provide, to a Policy Control Function (PCF), information for the first PDU session and the identifier.

20. The core network of claim 15, further configured to:
generate, for the UE, a UE Route Selection Policy (URSP) rule with a route selection descriptor (RSD) including a PDU session ID of the first PDU session.
